(19) United States
(12) Patent Application Publication
(10) Pub. No.: US 2002/0154613 A1
(43) Pub. Date: Oct. 24, 2002

(54) Method and system for a low-overhead mobility management protocol in the internet protocol layer

(75) Inventor: Sharif M. Shahrier, King of Prussia, PA (US)

Correspondence Address: VOLPE AND KOENIG, PC, DEPT ICC, SUITE 400, ONE PENN CENTER, 1617 JOHN F. KENNEDY BOULEVARD, PHILADELPHIA, PA, 19103, US

(73) Assignee: InterDigital Technology Corporation, Wilmington, DE

(21) Appl. No.: 09/997,922

(22) Filed: Nov. 30, 2001

Related U.S. Application Data
(60) Provisional application No. 60/270,190, filed on Feb. 21, 2001.
(60) Provisional application No. 60/270,767, filed on Feb. 22, 2001.
(60) Provisional application No. 60/296,168, filed on Jun. 6, 2001.

(51) Int. Cl. H04Q 7/00

(52) U.S. Cl. 370/331; 370/401

(57) ABSTRACT

A network system of Mobile Nodes (MNs) and Access Routers (ARs) for supporting mobile Internet communication is provided. Each AR has a unique IP address and access range in which the ARs communicates data to the MNs. Each MN is associated with a home AR and is identified with an IP address of a current location in a Node Location Table (NLT) associated with the home AR. A Corresponding Node (CN) and a Mobile Node (MN) communicate over the Internet using standard format datagrams. The CN sends a first datagram with a query as to the location of the MN in the data portion of the first datagram. The home AR replies with a second datagram with a query reply containing the current IP address of the MN in the data portion of the second datagram. The CN sends at least a third datagram having a data message protocol as the header protocol type and includes an identification of the MN and communication data for the MN in the data portion of the third datagram. The MN receives the communication data contained in the third datagram via the AR with which the MN is in communication. The method preferably includes the MN sending a datagram, when the MN communicates via an AR which is not its home AR, which includes an identification of the current IP address in its data portion. The home AR receives the MN datagram and uses the data portion thereof to update its NLT.

### CROSS-REFERENCE TO RELATED APPLICATIONS

This application claims priority from U.S. Provisional Patent Application Serial No. 60/270,190, filed Feb. 21, 2001; U.S. Provisional Patent Application Serial No. 60/270,767, filed Feb. 22,2001; and U.S. Provisional Patent Application Serial No.60/296,168, filed Jun. 6, 2001.

### FIELD OF THE INVENTION

The present invention relates to a system and method of mobile Internet communication capable of a high rate of data transmission which also supports many types of traffic flows, including both real-time and non real-time services. Specifically the present invention relates to a method of managing the mobility of a Mobile Node (MN) within multiple administrative domains.

### BACKGROUND OF THE INVENTION

In a mobile network, each Mobile Node (MN) is in communication with a single Access Point (AP) and receives communication via an Access Router (AR) associated with the AP. This situation represents a single point of attachment of the MN to the Internet. Conventionally, mobility management schemes use a two-level hierarchical approach to mobile Internet Protocols (IPs). Where a MN had moved from its home AP, the home AR receives and repackages a communication in a datagram from a source node, commonly called a Corresponding Node (CN), by adding a new header to a received datagram to redirect and “tunnel” the CN communication to the current IP address of the MN. The new/repackaged datagram encapsulates the original CN datagram in its data portion which is commonly referred to as internet protocol-in-internet protocol (IP-in-IP) encapsulation.

### SUMMARY

The present invention is directed to a novel system and method that combines mobility management with optimal routing for use over a mobile air interface.

A network system for supporting mobile Internet communication is provided. The network includes a plurality of Mobile Nodes (MNs) and a plurality of Access Routers (ARs). Each AR has a unique Internet Protocol (IP) address and a geographic access range in which the ARs communicates data to the MNs. Each MN is associated with a home AR and each AR has an associated Node Location Table (NLT). The NLT identifies each MN for which the AR is the home AR and the IP address of a current location of each such MN.

Each MN is movable outside the access range of its home AR to a location within the access range of a selected one of any of the other ARs to receive data via the selected AR. To do so, the MN communicates to its home AR the IP address of the selected AR as its current location. Thus, a data communication from another node, commonly referred to as a corresponding node (CN), to a selected MN is communicated to the selected MN by directing a query to the IP address of the selected MN's home AR, receiving the IP address of the current location of the selected MN from the NLT of the selected MN's home AR and directing the data communication to the received IP address.

Preferably, the network system includes a plurality of Access Points (APs). At least one AP is associated with each AR such that the MNs communicate with the ARs via the APs. Each AP has an access range in which the AP communicates data to MNs. The access ranges of the APs associated with a given AR collectively define the access range of that AR.

Preferably the network system also includes a plurality of Access Network Gateways (ANGs). At least one AR is associated with each ANG and each ANG is coupled with the Internet.

A novel method of communication between a Corresponding Node (CN) and a Mobile Node (MN) over the Internet using standard format datagrams is provided. In general the standard format for Internet datagrams are datagrams which have a header portion and a data portion where the header portion includes a source Internet Protocol (IP) address, a destination IP address and a protocol type. In the inventive method, the CN communicates with the Internet via an AR having a first IP address, the MN is associated with a home AR having a second IP address and the MN is in communication with the Internet via an AR having a third IP address. The second and third addresses are the same where the MN is communicating via its home AR.

The CN sends a first datagram identifying the first IP address as the header source IP address, the second IP address as the header destination address, an Internet Control Message Protocol (ICMP) as the header protocol type, and a query as to the location of the MN is included in the data portion of the first datagram. The home AR receives the first datagram from the CN and replies with a second datagram wherein the second IP address is the header source IP address, the first IP address is the header destination IP address, an ICMP is the header protocol type, and a query reply containing the third IP address is included in the data portion of the second datagram. The CN receives the second datagram and sends at least a third datagram having the first IP address as the header source IP address, the third IP address as the header destination IP address, a data message protocol as the header protocol type and includes an identification of the MN and communication data for the MN in the data portion of the third datagram. The MN receives the communication data contained in the third datagram via the AR with which the MN is in communication.

Preferably, the home AR maintains a Node Location Table (NLT) identifying each MN for which the AR is the home AR and the IP address of a current location of each such MN. The home AR, accordingly, creates the data portion of the second datagram by referencing the Node Location Table (NLT).

The method also preferably includes the MN sending a standard format datagram when the MN communicates with the Internet via an AR which is not its home AR. The MN datagram includes the third IP address as the header source IP address, the second IP address as the header destination IP address, a User Data Protocol (UDP) as the header protocol and includes an identification of the home AR and the third IP address in the data portion of the MN datagram. The home AR receives the MN datagram and uses the data portion thereof to update the NLT associated with the home AR.

The invention eliminates the need for internet protocol-in-internet protocol (IP-in-IP) encapsulation from corresponding node (CN) to MN, and still including the identity of the original CN in the IP datagram; eliminating any form of tunneling of packets to the MN by the CN, while the MN is away from its home. The elimination of these two overheads make it amenable for over the air interface communication in Third Generation Partnership Project (3GPP) mobile IP networks.

The traffic services supported include real-time such as video and voice and non real-time such as data. Each service will have different quality of service (QoS) requirements, delay and throughput characteristics and bit-error rates (BER). The present invention proposes a method for managing the mobility of a MN across all administrative domains. The protocol also supports optimal routing using Open Shortest Path First (OSPF).

Other objects and advantages of the system and method will become apparent to those skilled in the art from the following detailed description of the invention.

### BRIEF DESCRIPTION OF THE DRAWING(S)

FIG. 1 is a schematic diagram of an architecture and topology of a mobile network associated with the Internet;

FIG. 2 illustrates a Node Location Table for an Access Router in accordance with the teachings of the present invention;

FIG. 3 is a diagram of a conventional Internet datagram;

FIG. 4 is a diagram illustrating an Internet Control Message Protocol (ICMP) format in accordance with the teachings of the present invention; and

FIG. 5 is a diagram illustrating a User Data Protocol (UPD) messaging format in accordance with the teachings of the present invention.

TABLE OF ACRONYMS
The following acronyms are used herein:

| | |
|---|---|
| ANG | Access Network Gateway |
| AP | Access Point |
| AR | Access Router |
| BER | Bit-Error Rate |
| CN | Corresponding Node |
| DNS | Domain Name Server |
| HNI | Home Network Identifier |
| ICMP | Internet Control Message Protocol |
| IP | Internet Protocol |
| IP in IP | Internet Protocol-In-Internet-Protocol |
| MCN | Mobile Communication Network |
| MN | Mobile Node |
| NDP | Neighborhood Discovery Protocol |
| NLT | Node Location Table |
| OSPF | Open Shortest Path First |
| QoS | Quality of Service |
| TCP/IP | Transmission Control Protocol/Internet Protocol |
| UDP | User Datagram Protocol |
| 3GPP | Third Generation Partnership Project |

### DETAILED DESCRIPTION OF THE PREFERRED EMBODIMENT(S)

The present invention provides improvements over existing mobility management protocols, in particular, current 3GPP Mobile IP. The present invention eliminates the need for IP-in-IP encapsulation from a CN to a MN while including the identity of the original CN in the IP datagram, optimizes routing from sender to receiver, using OSPF, i.e. no need to tunnel via the home AR as in Mobile IP. Although this invention is applicable to both wireless and wireline networks, the reduction of overhead make the invention particularly useful for wireless over the air interface communication in 3GPP Mobile IP networks.

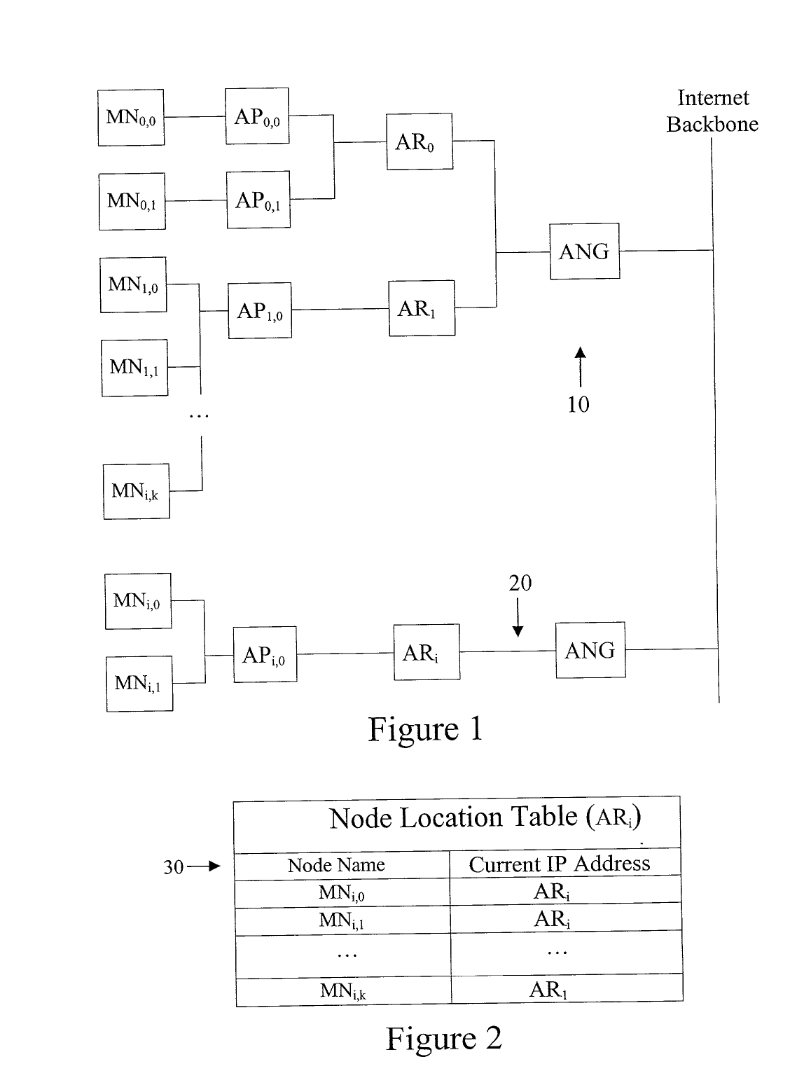

Referring to FIG. 1, there is shown the architecture and topology of a typical mobile communication network (MCN). The illustrated elements are associated with the following terminology and definitions. Mobile Node (MN) means an IP mobile terminal capable of changing its point of attachment to the internet. Access Point (AP) is an access point offering a wired or wireless air-interface connection to the MNs. The invention as applied to facilitating hand-off of a continuous communication would typically only be used in connection with wireless MN interfaces. Access Router (AR) is an IP router connected to one or more AP's. Each AR represents a single IP address. Access Network Gateway (ANG) is an IP gateway that connects the sub-networks to the Internet backbone. A combination of ARs connected to the same ANG belong to the same sub-network. Conversely, ARs connected to different ANGs are part of different sub-networks.

Each MN is pre-designated to a single sub-network called its “home network”. Each home network is identified by an identifier called the Home Network Identifier (HNI). Within its home network, the MN is connected to an access point called a “home AP”, which in turn is connected to a router called a “home AR”. Every AR has a unique IP address, so that the link between a MN and its home AR represents a single connection point to the Internet. Every MN in the network is assigned a fixed value called its host-name which is also commonly called its node name. The MN host-name does not change as the MN moves around the MCN. In particular, whenever any MN connected to the AR queries an Internet Domain Network Server (DNS) with a <HNI,host-name>pair of a specific MN, the DNS returns with the IP address of the home AR of the specific MN.

It is well known to send TCP/IP (Transmission Control Protocol/Internet Protocol) data packets to accomplish the transmission of data from a source node to a target node. A Destination IP Address in the IP header is used to route the packet to the target AR. The AR then broadcasts the data packet to all the AP's attached to it. The TCP “destination port number” field contains the host-name of the target MN. Each AP registers the host-names of the MNs that are currently attached to it. If an AP receives a packet whose port number (host-name) matches one of its registered host-names, the packet is transmitted through the interface to that MN. Otherwise the packet is discarded.

FIG. 1 schematically illustrates two sub-networks 10, 20 which each communicate with the Internet via its own ANG. The first sub-network 10 includes ARs, AR₀ and AR₁. The router AR₀ is associated with Access Points AP_{0,0} and AP_{0,1}. A Mobile Node MN_{0,0} is associated with AP_{0,0}, as its home AP and AR₀ as its home AR. A Mobile Node MN_{0,1}, is associated with AP_{0,1} as its home AP and AR₀ as its home AR. The second Access Router AR₁ of the sub-network 10 is associated with Access Point AP_{1,0}. Mobile nodes MN_{1,0} and MN_{1,1} have AP_{1,0} as their home AP and AR₁ as their home AR.

The second sub-network 20 includes Access Router ARᵢ and associated Access Point AP_{i,0}. Mobile nodes MN_{i,0} through MN_{i,k} are associated with Access Point AP_{1,0} as their home AP and Access Router ARᵢ as their home AR. Only mobile nodes MN_{i,0}, MN_{1,1} and MN_{i,k} are illustrated for simplicity. Mobile node MN_{1,k} is illustrated as in communication with the Internet via the first sub-network 10 through Access Point AP_{1,0} and Access Router AR₁.

The mobility management protocol of the present invention is designed for mobile nodes migrating around a Mobile Core Network. This protocol is suitable for MNs moving within a single sub-network or across multiple sub-networks. According to the protocol of the present invention the source is advised of the target's new location, every time the target moves to a new AR. If the MN moves to a new AP, but it is still attached to the same AR, it means that the IP address associated with the MN has not changed. Conversely, if a MN becomes attached to a different AR, the IP address is changed to indicate a new route. For example, mobile node MN_{i,k} is illustrated as being away from its home sub-network 20 and is in communication with the Internet via the address of router AR₁, not the address of router ARᵢ.

Mobile Node MN_{0,0} of FIG. 1, could potentially relocate to communicate through access point AP_{0,1} instead of its home access point AP_{0,0}. In that case, MN_{0,0} would remain in communication with the Internet via its home Access Router AR₀ so that its associated IP address would not have changed. However, if mobile node MN_{0,0}, accesses the Internet via Access Point AP_{1,0}, its IP address will change to the address of Access Router AR₁, even though MN_{0,0} remains within its home sub-network 10.

During the normal course of operation, MNs may move throughout the MCN. To facilitate the ability to locate an MN at any given time, each AR maintains a directory, called a “Node Location Table” (NLT). The NLT contains a listing of the node names (host-names) of all the MNs for which the AR is a home AR, and their current locations as reflected by the IP address of the AR with which the MN is in communication with the Internet. If the MN is at its home AR, then the IP address is that of its home AR. However, if the MN has moved away from its home AR, then the IP address is that of a foreign AR.

FIG. 2 illustrates a Node Location Table 30 associated with access router ARᵢ of the sub-network 20 with entries for the MNs as depicted in FIG. 1. The current location of the Mobile Nodes which are “home” is the IP address of ARᵢ. The Table 30 reflects that the current IP address for MN_{i,k} is the IP address of router AR₁ of sub-network 10 which is in conformance with the illustrated location of MN_{i,k}.

Before IP datagrams can be sent to a target MN, a TCP connection has to be established between the AR of the source or corresponding node (CN) and the AR of the target MN. Before such an event, the source CN ascertains the target mobile's current location. This is accomplished by exchanging a pair of ICMP (Internet Control Message Protocol) messages using standard format datagrams between the peers. ICMP is a well known protocol used within the data portion of standard format Internet datagrams. ICMPs have a TYPE field of which types 20 and 21 are heretofore not used.

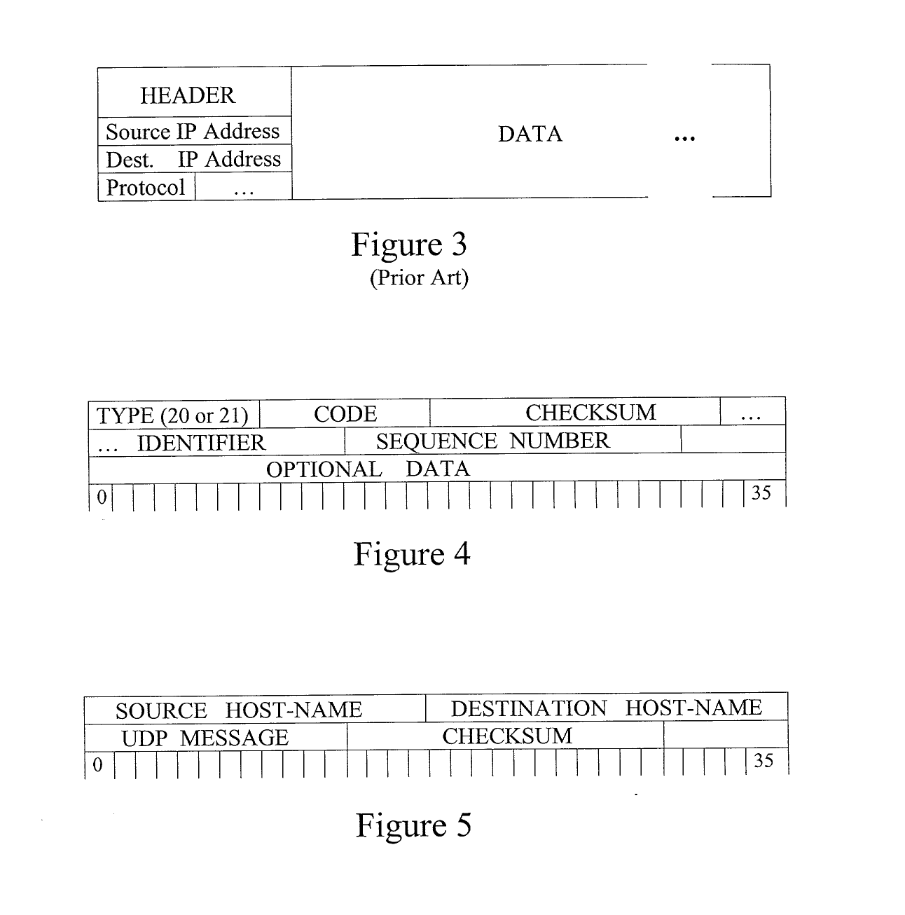

FIG. 3 illustrates a standard format datagram for Internet communications. The datagram includes a header portion and a data portion. The header portion includes a source IP address field, a destination IP address field, and a protocol type field. The data portion corresponds to the type of protocol indicated in the header protocol type field.

FIG. 4 illustrates a format of an ICPM which is communicated in the data portion of a standard format Internet datagram. The ICMP of FIG. 4 includes a type field, a code field, a checksum field, an identifier field, a sequence number field, and an optional data field in accordance with conventional ICMP format. The ICMPs of the present invention preferably use type 20 or in the type field as explained in more detail below, but could use any previously undefined type for the purposes of this invention.

To communicate data from a CN to an MN, the CN first indexes into a DNS using the node-name of the target MN and retrieves the MN's home IP address in accordance with conventional protocol. Next, the CN constructs a standard format datagram containing a header portion and an ICMP node location query message in a data portion. The CN datagram header contains the IP address of the CN's AR as the header source IP address, the MN's home AR IP address as the header destination address, and ‘1’, which currently is assigned for ICMPs as the header protocol type. The ICMP node location query message is provided with the following field settings:

TYPE=20—Node location query.

IDENTIFIER=node-name—Node-name of target MN.

The rest of the fields are filled in a conventional manner and the resulting ICMP message is placed in the data portion of the CN IP datagram frame. The resulting IP datagram is sent to the target MN's home AR. When received, the target MN's home AR evaluates the checksum data to ascertain proper reception of the ICMP query message from the CN. If the checksum does not indicate a proper ICMP message no response is made and the CN must resend its query. If the ICMP message is properly received, the target MN's home AR uses the CN's ICMP's Identifier to index into the NLT and retrieve target MN's current IP address. The target MN's home AR then constructs a responsive datagram having a reply ICMP message and sends it back to the CN. The responsive datagram's header contains the target MN's home AR IP address as the header source IP address, the IP address of the CN's AR as the header destination address, and ‘1’, which currently is assigned for ICMPs, as the header protocol type. The ICMP node location query reply message is provided with the following field settings:

TYPE=21—Node location query reply.

IDENTIFIER=Node-name of CN.

OPTIONAL DATA=Target MN's current IP address.

CODE=1 or 13 —‘1’ indicating that the MN is unavailable and ‘13’ indicating that the MN is available.

The rest of the fields are filled in a conventional manner and the resulting ICMP message is placed in the data portion of the responsive datagram frame. Optionally, the MN's home AR can send a message to the target MN at the IP location indicated in the NLT to determine if the MN is actively connected to the Internet. If no acknowledgment of that inquiry is received in a selected time out period, the MN's home AR would use CODE ‘1 ’ in the reply to the CN. In that case the AR could also be configured to reset the current location of the target MN to the home AR in the NLT.

The resulting IP datagram is sent to the CN. When received, the CN's AR evaluates the checksum data to ascertain proper reception of the ICMP query reply message. If the checksum does not indicate a proper ICMP message no action is taken and the CN must resend its query since it will not receive the reply. If the ICMP message is properly received, the CN's AR uses the ICMP's Identifier to forward the target MN's current IP address to the CN and the information as to whether the CN is available.

Once the IP address is known, a TCP connection is established between the sender CN and receiver MN and the data transfer takes place. Assuming the MN is available, the CN constructs one or more TCP/IP datagrams having the data for the target MN and sends it directly to the MN at its current IP address. The TCP/IP datagrams headers contain the IP address of the CN's AR as the header source IP address, the target MN's current AR IP address as the header destination address, and ‘6’, which currently is assigned for TCP/IP data, as the header protocol type.

If a target MN relocates to a new AP while it is still communicating with the CN, ‘hand’ off is performed. For hand off, the CN is notified of the new location of the target MN, so that the target MN can continue to receive data seamlessly. If, after relocation, the new AP of the target MN is connected to the same AR, i.e. the MN's current IP address remains the same and the connection can continue to proceed as normal. If, on the other hand, the MN moves to an AP with a different AR, the MN's current IP address changes and the CN needs to be notified of the new IP address. Once notified, the CN uses the new current IP address of the target MN as the header destination address in the TCP/IP datagrams.

To re-direct the data traffic flow, the MN sends a User Data Protocol (UDP) message to each of the CN and the MN's home AR containing the new current IP address of the target MN. Where an ongoing communication is not being conducted with a CN, a UDP message datagram is only sent to the MN's home AR. This also occurs upon MN reconnection, if the MN disconnects from the Internet altogether by being relocated to a position outside the access range of all compatible APs or by simply being turned off. FIG. 5 illustrates the format of a UDP message used in accordance with the teachings of the present invention.

The UDP message includes a source host-name field, a destination host-name field, a UDP message field and a checksum field. In the MN's UDP message, the node name of the MN is placed in the source host-name field and the CD's node name or MN's home AR's node name, respectively, is placed in the destination host-name field. The new MN current IP address is placed in the UDP message field of the UDP message. The UDP message length is normally set to 12 bytes because it is 3 words long.

The UDP message is included as the data portion of a standard format datagram as illustrated in FIG. 3. The target MN's datagram header contains the IP address of the CN's AR or the MN's home AR's IP address as the header destination IP address, respectively, and the protocol type is indicated as “17”, which is currently the identification assigned for UDP messages.

The header source IP address of the MN's UDP message datagram will either be the “old” MN current IP address or the “new” MN current IP address dependent upon the type of hand over which is being implemented. A preferred method of implementing hand over is “make before break” in which the MN obtains the address of the new AR with which it will communicate before ceasing communication via the existing (“old”) AR. In such instances, the MN's datagram header source IP address will be the existing (“old”) IP address with the MN's new location IP address being stored in the UDP message field of the UDP message within the MN's datagram. Otherwise, the UDP message is communicated after communication has commenced with the target MN via the new AR and the MN's UDP message datagram will have the address of the new AR as the header source IP address.

In order for the target MN to obtain the address of the new AR with which it will communicate, the MN sends a conventional Neighborhood Discovery Protocol (NDP) message. The NDP message is a standard protocol which returns the IP address of the router associated with the AP which has an access range into which the target MN has relocated. The MN then sends the UDP message datagrams to advise the CN and the MN's home AR of the NDP results. The home AR updates its NLT with the new IP address received in the MN's UDP message datagram.

Optionally, the home AR can send an acknowledgment UDP message or other type of acknowledgment message to the MN to confirm the updating of the NLT. This is important to handle the case where the check sum of the UDP received by the MN's home AR is bad. In such case, the NLT will not be updated since the home AR will not process the information in the UDP. Acknowledgment by the home AR to the MN permits the MN to resend the UDP message, in the absence of an acknowledgment, within a selected time-out period.

In the case where the target MN moves while receiving data from a CN, the MN sends the UDP message containing the results of the NDP to the CN. The CN then redirects the TCP/IP datagrams by using the new AR IP address as the header destination IP address in the TCP/IP datagrams. For data blocks being transmitted in the transitional period, the MN and CN can communicate to determine the last successfully received TCP/IP datagram by the target MN from the CN so that the CN can resend any missing TCP/IP datagrams to the target MN at the new IP address. Alternatively, provisions can be made to forward datagrams which are not received by the target MN from the “old” AR to the “new” AR.

Other variations and alternatives will be recognized by those of ordinary skill in the art as within the scope of the invention are intended to be included herein.

What is claimed is:

1. A network system for supporting mobile Internet communication comprising:
a plurality of Mobile Nodes (MNs);
a plurality of Access Routers (ARs), each having unique Internet Protocol (IP) address and a geographic access range in which the ARs communicates data to the MNs;
each MN associated with a home AR;
each AR having an associated Node Location Table (NLT) identifying each MN for which the AR is the home AR and the IP address of a current location of each such MN; and
each MN being movable outside the access range of its home AR to a location within the access range of a selected one of any of the other ARs to receive data via the selected AR by communicating to its home AR the IP address of the selected AR as its current location whereby a data communication from a corresponding node (CN) to a selected MN is communicated to the selected MN by directing a query to the IP address of the selected MN's home AR, receiving the IP address of the current location of the selected MN from the NLT of the selected MN's home AR and directing the data communication to the received IP address.

2. A network system according to claim 1 further comprising:
a plurality of Access Points (APs), at least one AP associated with each AR such that said MNs communication with said ARs via said APs; and
each AP having an access range in which the AP communicates data to MNs whereby the access ranges of the APs associated with a given AR collectively define the access range of that AR.

3. A network system according to claim 2 further comprising a plurality of Access Network Gateways (ANGs), at least one AR associated with each ANG and each ANG being coupled with the Internet.

4. A method of communication between a Corresponding Node (CN) and a Mobile Node (MN) over the Internet using datagrams having a header portion and a data portion where the header portion includes a source Internet Protocol (IP) address, a destination IP address and a protocol type wherein the CN communicates with the Internet via a router having a first IP address, the MN is associated with a home Access Router (AR) having a second IP address and the MN is in communication with the Internet via an AR having a third IP address, the method comprising:
the CN sending a first datagram identifying the first IP address as the header source IP address, the second IP address as the header destination address, an Internet Control Message Protocol (ICMP) as the header protocol type, and a query as to the location of the MN is included in the data portion of said first datagram;
the home AR receiving the first datagram from the CN and replying with a second datagram wherein the second IP address is the header source IP address, the first IP address is the header destination IP address, an ICMP is the header protocol type, and a query reply containing the third IP address is included in the data portion of the second datagram;
the CN receiving the second datagram and sending at least a third datagram having the first IP address as the header source IP address, the third IP address as the header destination IP address, a data message protocol as the header protocol type and includes an identification of the MN and communication data for the MN in the data portion of said third datagram; and
the MN receiving the communication data contained in said third datagram via the AR with which the MN is in communication.

5. A method according to claim 4 wherein
the home AR maintains a Node Location Table (NLT) identifying each MN for which the AR is the home AR and the IP address of a current location of each such MN;
the current location IP address being the third IP address which is equal to the second IP address if the MN is in communication with the Internet via its home AR; and
the home AR creates the data portion of the second datagram by referencing the Node Location Table (NLT).

6. The method according to claim 5, further comprising:
the MN sending a datagram when the MN communicates with the Internet via an AR which is not its home AR wherein the MN datagram includes the third IP address as the header source IP address, the second IP address as the header destination IP address, a User Data Protocol (UDP) as the header protocol and includes an identification of the home AR and the third IP address in the data portion of the MN datagram; and
the home AR receives the MN datagram and uses the data portion thereof to update the NLT associated with the home AR.
